(19) United States
(12) Patent Application Publication
(10) Pub. No.: US 2013/0149680 A1
(43) Pub. Date: Jun. 13, 2013

(54) METHODS AND SYSTEMS FOR TEACHING A NON-NATIVE LANGUAGE

(71) Applicants: Emily Nava, Staunton, VA (US); Joseph Tepperman, Denver, CO (US)

(72) Inventors: Emily Nava, Staunton, VA (US); Joseph Tepperman, Denver, CO (US)

(21) Appl. No.: 13/314,697

(22) Filed: Dec. 8, 2011

(51) Int. Cl. G09B 19/06

(52) U.S. Cl. 434/157

(57) ABSTRACT

A method and system for teaching language prosody includes audibly conveying a phrase or sentence; audibly conveying a non-lexical version of at least a portion of the phrase or sentence; prompting a language learner to repeat said at least portion of said phrase or sentence in a non-lexical form; determining in a computer process whether said non-lexical phrase or sentence repeated by said language learner was performed correctly; and indicating to said language learner whether said non-lexical phrase or sentence repeated by said language learner was performed correctly.

### FIELD

This invention relates to computer-based language learning methods and systems. More particularly, this invention relates to methods and systems for teaching a person the rhythm and intonation of a non-native language.

### BACKGROUND

Prosody, in the context of linguistics, comprises the rhythm and intonation of natural language or speech. Various features of speech may be shown by prosody that are not evident in the grammar or vocabulary of the speech including emotion, sarcasm, and emphasis, to name a few.

The rhythm element of prosody includes, among other items, the pattern of beats in the speech. The rhythm of English may include stressed syllables surrounded by one or more unstressed syllables. Among the many differentiating qualities, the stressed syllable in English is typically longer than the unstressed syllable. In contrast to English, the duration of stressed and unstressed in Japanese and Korean have much less variance.

The intonation element of prosody includes the pattern of pitch rise and fall over a word, phrase, or sentence. Intonation contours are patterns of intonation associated with a given word, phrase, or sentence. Examples of intonation in the English language include how the intonation tends to rise at the end of a question and how the intonation tends to fall in a declarative statement.

All languages have intonation, but languages can differ in the types of intonation contours that are characteristic of natural speech. A person can learn a second language (non-native) by any number of conventional curriculums. However, such conventional curriculums merely teach the grammar and vocabulary of the second language, but not the rhythm or intonation of the second language. As a result, the learner sounds much less like a native speaker, and the learner's incorrect intonation can change the meaning of a phrase spoken in the second language. Hence, learning the prosody of language is very important for intelligibility and native-like speech.

Accordingly, methods and systems are needed for teaching a person the rhythm and intonation of a non-native language.

### SUMMARY

A method is disclosed herein for teaching language prosody to a language learner. In one exemplary embodiment, the method comprises audibly conveying a phrase or sentence; audibly conveying a non-lexical version of at least a portion of the phrase or sentence; prompting the language learner in a computer process to repeat said at least portion of said phrase or sentence in a non-lexical form; determining in a computer process whether said non-lexical phrase or sentence repeated by said language learner was performed correctly; and indicating to said language learner whether said non-lexical phrase or sentence repeated by said language learner was performed correctly.

In another exemplary embodiment, the method comprises passively exposing a language learner to audible and visual lexical and non-lexical versions of an entire phrase or sentence and to audible and visual lexical and non-lexical portions of the phrase or sentence, wherein each of the portions is smaller than the previous portion such that the entire phrase or sentence is gradually broken down into its most basic elements; and prompting the language learner to actively compose lexical and non-lexical versions of the lexical and non-lexical portions of the phrase or sentence and the lexical and non-lexical versions of the phrase or sentence starting with the most basic elements and finishing with the entire phrase or sentence.

Further disclosed herein is a system for teaching language prosody to a language learner. In one exemplary embodiment, the system comprises an audio output device for audibly conveying a phrase or sentence in at least one of a lexical and a non-lexical form and portions thereof, to the language learner; a prompting device for prompting the language learner to repeat said phrase or sentence and portions thereof and indicating to said language learner whether said phrase or sentence and portions thereof have been repeated correctly by said language learner; at least one input device for allowing the language learner to repeat said phrase or sentence and said portions thereof in at least one of a lexical and non-lexical form; and a controller for determining whether said phrase or sentence and portions thereof repeated by said language learner was performed correctly.

Also disclosed herein is a computer program product for teaching language prosody. The computer program product comprises a computer readable medium having computer program logic recorded thereon to program a computing system reading the medium to teach language prosody, wherein the computer program product, in one exemplary embodiment comprises code for audibly conveying a phrase or sentence; code for audibly conveying a non-lexical version of at least a portion of the phrase or sentence; code for prompting a language learner to repeat said at least portion of said phrase or sentence in a non-lexical form; code for determining whether said non-lexical phrase or sentence repeated by said language learner was performed correctly; and code for indicating to said language learner whether said non-lexical phrase or sentence repeated by said language learner was performed correctly.

### BRIEF DESCRIPTION OF THE DRAWINGS

FIG. 1 illustrates a block diagram of a system according to an embodiment of the disclosure.

FIG. 2 illustrates a flow chart of a method performed by a non-native language rhythm learning tool, according to an exemplary embodiment of the disclosure.

FIGS. 3A-3L illustrate exemplary graphical representations of prominent and less prominent syllables in an exemplary sentence, in the chunks of the sentence, and in the words of the sentence, described in the rhythm method of FIG. 2.

FIG. 4 illustrates a flow chart of a method performed by a non-native language intonation learning tool, according to an exemplary embodiment of the disclosure.

FIGS. 5A and 5B illustrate exemplary visual representations of an exemplary sentence described in the intonation method of FIG. 3.

FIG. 5C illustrates a graphical representation of the contours of an exemplary pitch graph.

### DETAILED DESCRIPTION

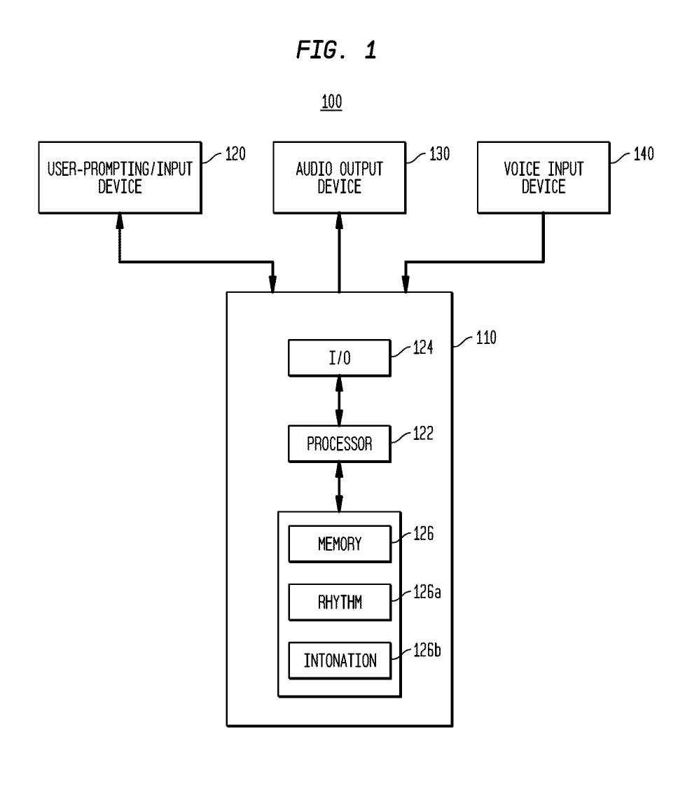

FIG. 1 illustrates a block diagram of a system 100 according to an exemplary embodiment of the disclosure. The system 100 comprises a controller 110, a user-prompting/input device 120, an audio output device 130, and a voice input device 140. The system 100 may comprise hardware associated with a conventional desk, laptop, or tablet personal computer (PC), a smart phone, or other computing device.

The controller 120 comprises a processor 122, input/output (I/O) circuitry 124, and a memory 126. The processor 122 executes rhythm and intonation software routines 126a and 126b, respectively, stored in memory 126. The I/O circuitry 124 forms an interface between the various functional elements communicating with controller 120, thereby allowing the controller 120 to communicate with the user-prompting/input device 120, the audio output device 130, and the voice input device 140.

Although controller 120 is depicted as a general-purpose computer that is programmed to perform various control functions in accordance with the present disclosure, the methods described herein can be implemented in hardware as, for example, an application-specific integrated circuit (ASIC). As such, the methods described herein should be broadly interpreted as being equivalently performed by software, hardware, or a combination thereof.

The user-prompting/input device 120 in one embodiment may comprise a conventional display, keyboard, and mouse/touchpad arrangement in the case of a desk or laptop PC. In other embodiments, the user-prompting/input device 120 may comprise a conventional touch-screen in the case of a tablet or smart phone.

The audio output device 130 may comprise a convention audio speaker or pair of audio speakers or any other suitable device for generating sound. The voice input device 140 may comprise a microphone or any other suitable device for converting a users voice into an electrical signal that can be processed by the controller 110.

The rhythm and intonation routines are implemented by the processor 122 to provide rhythm and intonation engines that generate rhythm and intonation entrainment exercises which are provided to a user on audio output device 130 and/or display/touchscreen of the user-prompting/input device 120. The rhythm and intonation engines also process voice and/or keyboard/mouse/touchscreen data provided by the user via the voice input device 140 and/or user-prompting/input device 120. Each of these engines converts the voice and/or keyboard/mouse/touchscreen data provided by the user into a graphical representation that is displayed on the display/touchscreen of the system to provide visual feedback to the user of his or her performance.

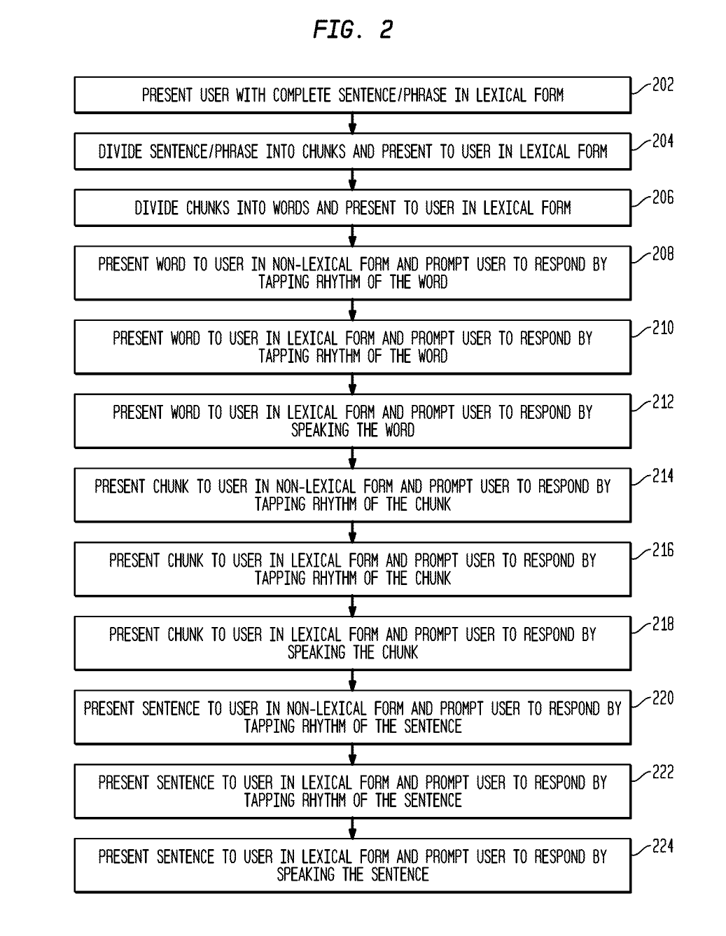

FIG. 2 illustrates a flow chart of a method performed by a non-native language rhythm learning tool, according to an exemplary embodiment of the disclosure. In the context of FIG. 1, system 100 operates as such a tool when processor 122 implements the rhythm software routine 126a stored in the memory 126. The method comprises first and second sequences of operations or steps. The first sequence (steps 202, 204, and 206) focuses on the user passively identifying the rhythmic composition of a non-native language and the second sequence (steps 208, 210, 212, 214, 216, 218, 220, 222, and 224) focuses on the user actively reproducing the rhythmic composition of the non-native language. The first and second sequences define an “hourglass paradigm” of operations which allow the user to acquire the rhythm of the non-native language.

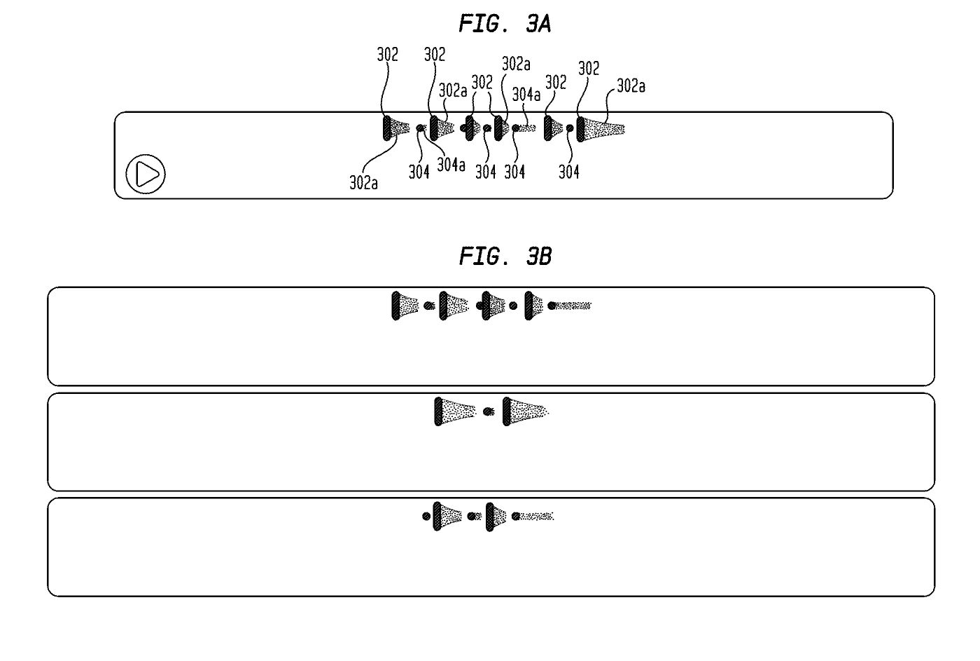

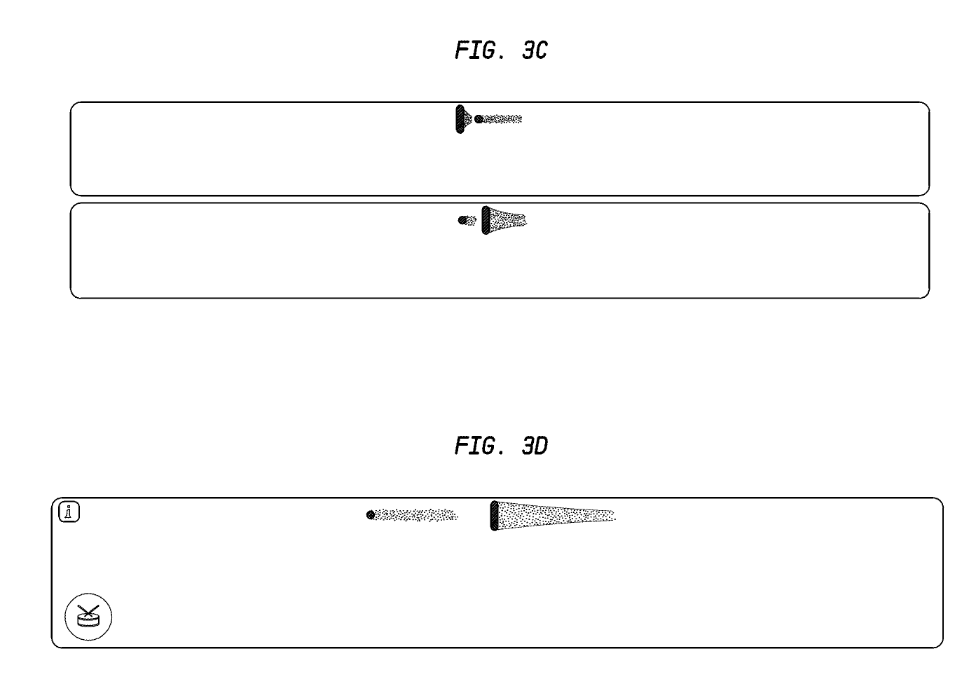

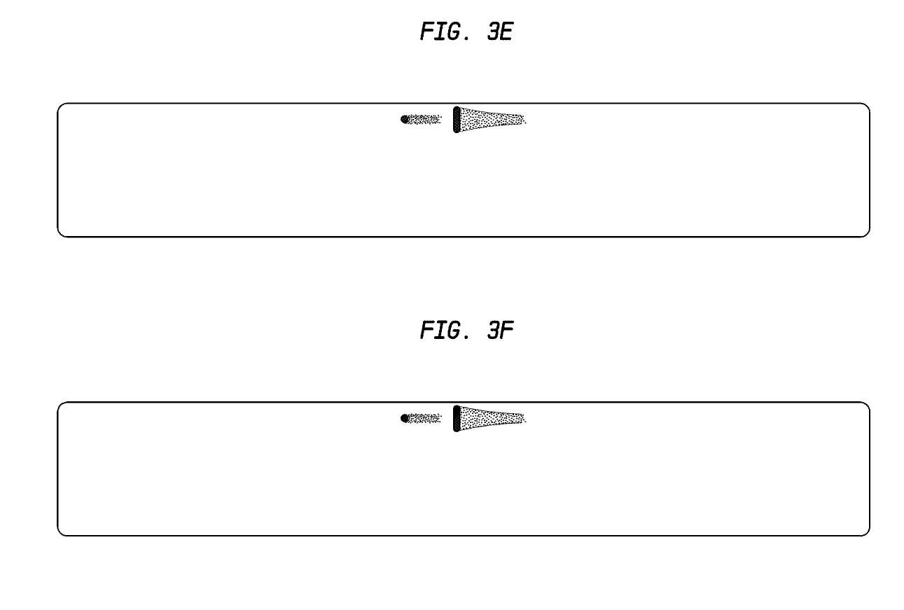

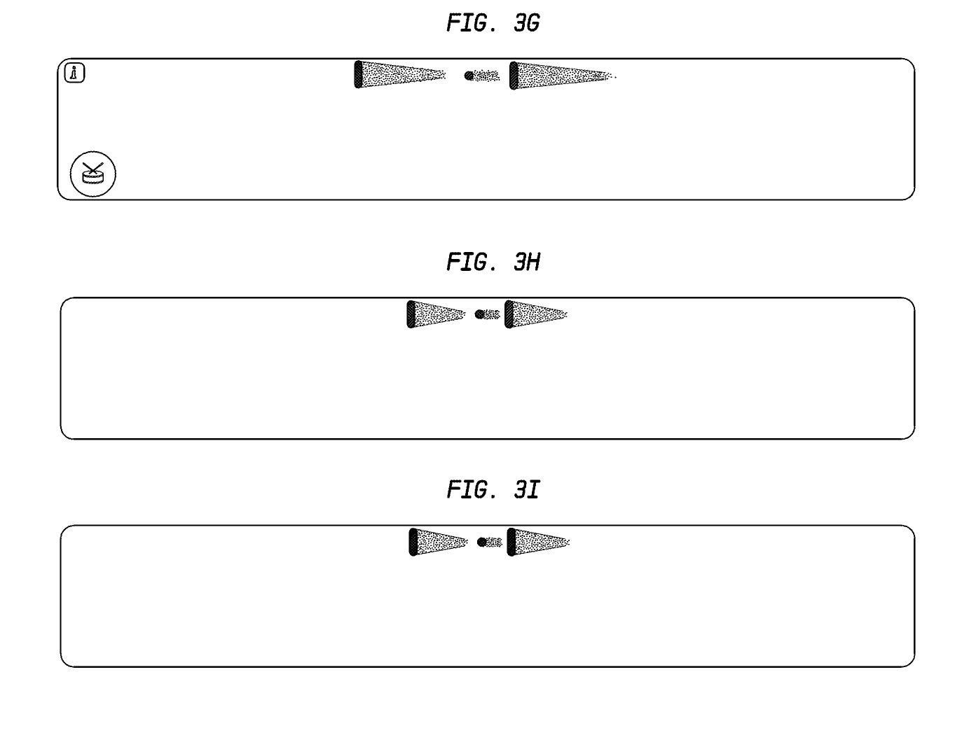

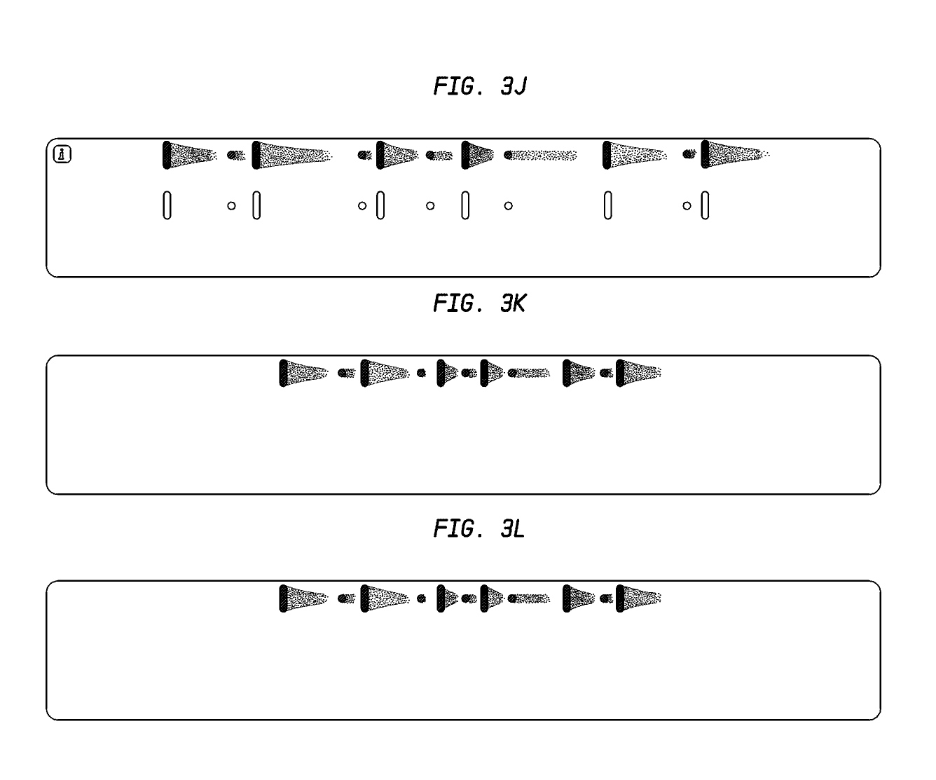

In step 202, a complete sentence or phrase is presented to the user in a lexical audio form (spoken normally) via the audio output device 130, while the display/touchscreen of the user-prompting/input device 120 presents the user with a graphical representation of the sentence or phrase, which indicates prominent and less prominent syllables of all the words in the sentence or phrase. In response, the user listens to the sentence or phrase and views the graphical representation of the sentence or phrase in a passive manner, i.e., without taking any action. FIG. 3A illustrates a graphical representation of an exemplary sentence or phrase presented to the user as per step 202 where reference numeral 302 denotes prominent syllables, reference numeral 304 denotes less prominent syllables, and reference numerals 302a and 304a denote the duration of the syllables 302 and 304.

In step 204, the sentence or phrase provided in step 202 is divided into chunks and the chunks are sequentially presented to the user in a lexical audio form via the audio output device 130 while the display/touchscreen of the user-prompting/input device 120 presents the user with a graphical representation of the chunks, which indicates prominent and less prominent syllables of all the words in the chunks. In response, the user listens to each chunk and views the corresponding graphical representation of the chunk in a passive manner. FIG. 3B illustrates graphical representations of the chunks (derived from the exemplary sentence or phrase shown in FIG. 3A) presented to the user as per step 204.

In step 206, the sentence or phrase chunks provided in step 204 are divided into words, which are sequentially presented to the user in a lexical audio form via the audio output device 130 while the display/touchscreen of the user-prompting/input device 120 presents the user with a graphical representation of the words, which indicates the prominent and less prominent syllables in each word. In response, the user listens to each word and views the corresponding graphical representation of the word in a passive manner. FIG. 3C illustrates graphical representations of the words (derived from the chunks shown in FIG. 3B) presented to the user as per step 204.

In step 208, a first one of the words presented above in step 206, is presented to the user in a non-lexical audio form (i.e., the word is not spoken, but instead, the rhythm of the word is audibly presented to the user with a sound such as “dah da,” a drum beat, and/or any other suitable sound or combination sounds, some of which can be non-vocal), via the audio output device 130 while the display/touchscreen of the user-prompting/input device 120 preferably presents the user with a graphical representation of the word, which may pictorially indicate the prominent and less prominent syllables in the word. The pictorial representation may also indicate rhythm and/or duration or specific syllables or even phonemes.

In response, the user listens to the non-lexical version of the word, and is prompted by the display/touchscreen of the user-prompting/input device 120 to actively respond by tapping on the appropriate keys of the keyboard (of a desk or laptop PC) in a manner which mimics the rhythm of the word, where one key is used for tapping the prominent syllables and another key is used for tapping the less prominent syllables. In the case of a tablet PC or smartphone, the user would actively respond by tapping on two buttons displayed on the touchscreen, where one of the buttons is tapped for the prominent syllables and the other button is tapped for the less prominent syllables. The processor 122 processes the user's tapping input and displays a graphical representation of the tapped non-lexical word (as prominent and non-prominent syllables) on the display/touchscreen of the user-prompting/input device 120 for viewing by the user so that the user can observe whether the user's tapping input correctly or incorrectly followed the rhythm of the word. FIG. 3D illustrates a graphical representation of the tapped non-lexical version of the word.

In step 210, the same word presented in step 208 is presented to the user in a lexical audio form, via the audio output device 130 while the display/touchscreen of the user-prompting/input device 120 presents the user with a graphical representation of the lexical word, which indicates the prominent and less prominent syllables in the word. In response, the user listens to the lexical version of the word, and is prompted by the display/touchscreen of the user-prompting/input device 120 to actively respond by tapping on the appropriate keys or buttons of the keyboard or touchscreen in a manner that mimics the rhythm of the word. The processor 122 processes the user's tapping input and graphically displays the tapped representation of the word on the display/touchscreen of the user-prompting/input device 120, as shown in FIG. 3E so that the user can observe whether the user's tapping input correctly or incorrectly followed the rhythm of the word.

In step 212, the same word presented in steps 208 and 210 is again presented to the user in a lexical audio form, via the audio output device 130 while the display/touchscreen of the user-prompting/input device 120 presents the user with a graphical representation of the word lexical which indicates the prominent and less prominent syllables in the word. In response, the user listens to the lexical version of the word, and is prompted by the display/touchscreen of the user-prompting/input device 120 to actively respond by saying the word into the voice input device 140 with the proper rhythm. The processor 122 processes the user's voice input and graphically displays the spoken word (as prominent and non-prominent syllables) on the display/touchscreen of the user-prompting/input device 120 as shown in FIG. 3F so that the user can observe whether the spoken word correctly or incorrectly followed the rhythm of the word.

The other words presented in step 206 are then processed as described in steps 208, 210, and 212 and step 212 may be repeated at least a second time for each word.

In step 214, a first one of the chunks presented above in step 204, is presented to the user in a non-lexical audio form, via the audio output device 130 while the display/touchscreen of the user-prompting/input device 120 presents the user with a graphical representation of the non-lexical chunk, which indicates the prominent and less prominent syllables in the chunk. In response, the user listens to the non-lexical version of the chunk, and is prompted by the display/touchscreen of the user-prompting/input device 120 to actively respond by tapping on the appropriate keys or buttons of the keyboard or touchscreen in a manner which mimics the rhythm of the non-lexical chunk. The processor 122 processes the user's tapping input and displays a graphical representation of the tapped chunk (as prominent and non-prominent syllables) on the display/touchscreen of the user-prompting/input device 120 for viewing by the user. FIG. 3G illustrates a graphical representation of the tapped non-lexical version of the chunk so that the user can observe whether the user's tapping input correctly or incorrectly followed the rhythm of the chunk.

In step 216, the same chunk presented in step 214 is presented to the user in a lexical audio form, via the audio output device 130 while the display/touchscreen of the user-prompting/input device 120 presents the user with a graphical representation of the lexical chunk, which indicates the prominent and less prominent syllables in the chunk. In response, the user listens to the lexical version of the chunk, and is prompted by the display/touchscreen of the user-prompting/input device 120 to actively respond by tapping on the appropriate keys or buttons of the keyboard or touchscreen in a manner that mimics the rhythm of the chunk. The processor 122 processes the user's tapping input and graphically displays the tapped representation of the lexical chunk on the display/touchscreen of the user-prompting/input device 120, as shown in FIG. 3H so that the user can observe whether the user's tapping input correctly or incorrectly followed the rhythm of the chunk.

In step 218, the same chunk presented in steps 214 and 216 is again presented to the user in a lexical audio form, via the audio output device 130 while the display/touchscreen of the user-prompting/input device 120 presents the user with a graphical representation of the chunk, which indicates the prominent and less prominent syllables in the chunk. In response, the user listens to the lexical version of the chunk, and is prompted by the display/touchscreen of the user-prompting/input device 120 to actively respond by saying the chunk into the voice input device 140 with the proper rhythm. The processor 122 processes the user's voice input and graphically displays the spoken chunk (as prominent and non-prominent syllables) on the display/touchscreen of the user-prompting/input device 120 as shown in FIG. 31 so that the user can observe whether the spoken chunk correctly or incorrectly followed the rhythm of the chunk.

The other chunks presented in step 204 are then processed as described in steps 214, 216, and 218 and step 218 may be repeated at least a second time for each chunk.

In step 220, the entire sentence presented above in step 202, is presented to the user in a non-lexical audio form, via the audio output device 130 while the display/touchscreen of the user-prompting/input device 120 presents the user with a graphical representation of the non-lexical sentence, which indicates the prominent and less prominent syllables in the sentence. In response, the user listens to the non-lexical version of the sentence, and is prompted by the display/touchscreen of the user-prompting/input device 120 to actively respond by tapping on the appropriate keys or buttons of the keyboard or touchscreen in a manner which mimics the rhythm of the non-lexical sentence. The processor 122 processes the user's tapping input and displays a graphical representation of the tapped non-lexical sentence (as prominent and non-prominent syllables) on the display/touchscreen of the user-prompting/input device 120 for viewing by the user so that the user can observe whether the user's tapping input correctly or incorrectly followed the rhythm of the sentence. FIG. 3J illustrates a graphical representation of the tapped non-lexical version of the sentence.

In step 222, the same sentence presented in step 220 is presented to the user in a lexical audio form, via the audio output device 130 while the display/touchscreen of the user-prompting/input device 120 presents the user with a graphical representation of the lexical sentence, which indicates the prominent and less prominent syllables in the sentence. In response, the user listens to the lexical version of the sentence, and is prompted by the display/touchscreen of the user-prompting/input device 120 to actively respond by tapping on the appropriate keys or buttons of the keyboard or touchscreen in a manner that mimics the rhythm of the sentence. The processor 122 processes the user's tapping input and graphically displays the tapped representation of the lexical sentence on the display/touchscreen of the user-prompting/input device 120, as shown in FIG. 3K so that the user can observe whether the user's tapping input correctly or incorrectly followed the rhythm of the sentence.

In step 224, the same sentence presented in steps 220 and 222 is again presented to the user in a lexical audio form, via the audio output device 130 while the display/touchscreen of the user-prompting/input device 120 presents the user with a graphical representation of the lexical sentence, which indicates the prominent and less prominent syllables in the sentence. In response, the user listens to the lexical version of the sentence, and is prompted by the display/touchscreen of the user-prompting/input device 120 to actively respond by saying the sentence into the voice input device 140 with the proper rhythm. The processor 122 processes the user's voice input and graphically displays the spoken sentence (as prominent and non-prominent syllables) on the display/touchscreen of the user-prompting/input device 120, as shown in FIG. 3L so that the user can observe whether spoken sentence correctly or incorrectly followed the rhythm of the sentence. Step 224 may be repeated at least a second time for the entire sentence.

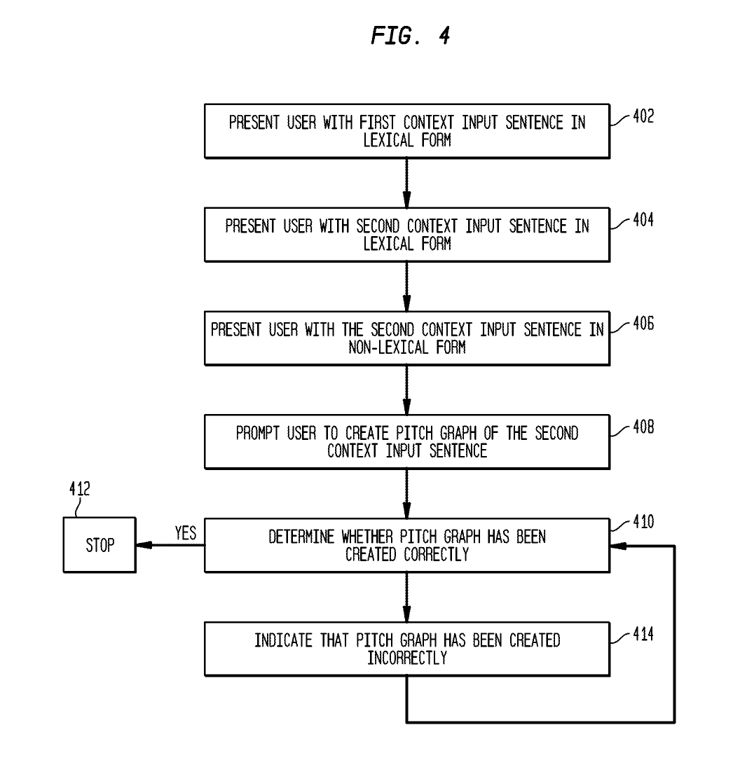

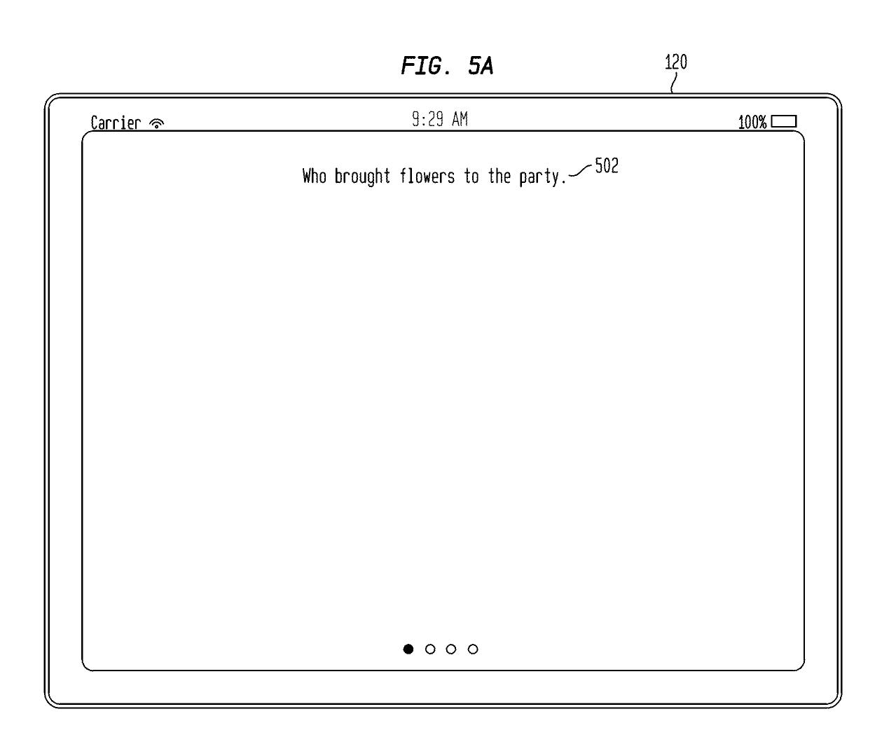

FIG. 4 illustrates a flow chart of a method performed by a non-native language intonation learning tool, according to an exemplary embodiment of the disclosure. In the context of FIG. 1, system 100 operates as such a tool when processor 122 implements the intonation software routine 126b stored in the memory 126. The intonation tool exposes the user to intonation contours (i.e., the pattern of pitch rise and fall over a word, phrase, or sentence) that may be grounded, for example, in discourse contexts (i.e., question and answer pairs).

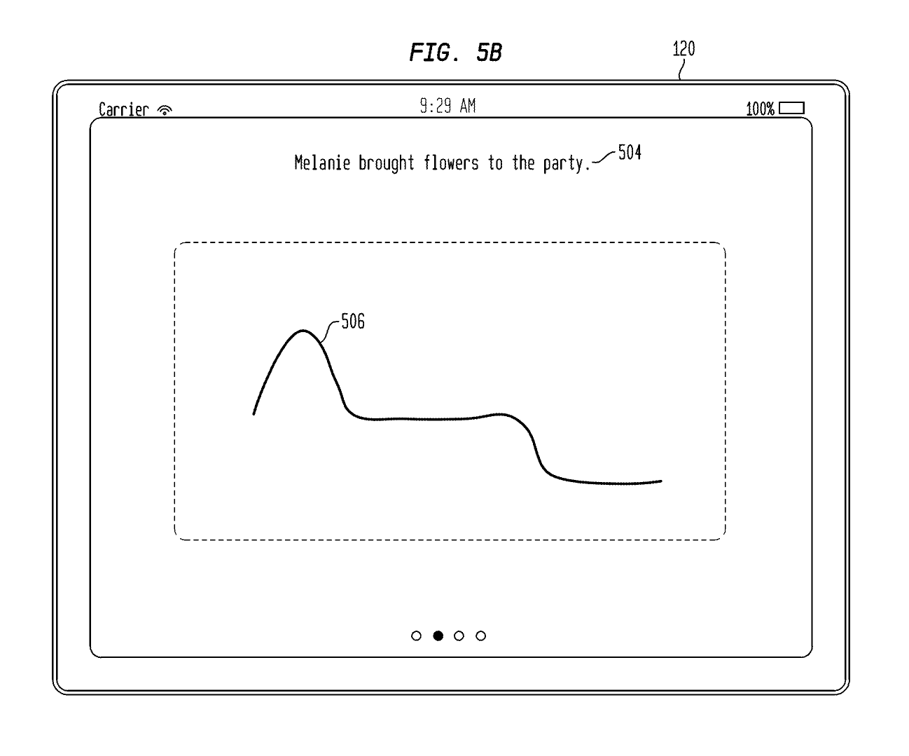

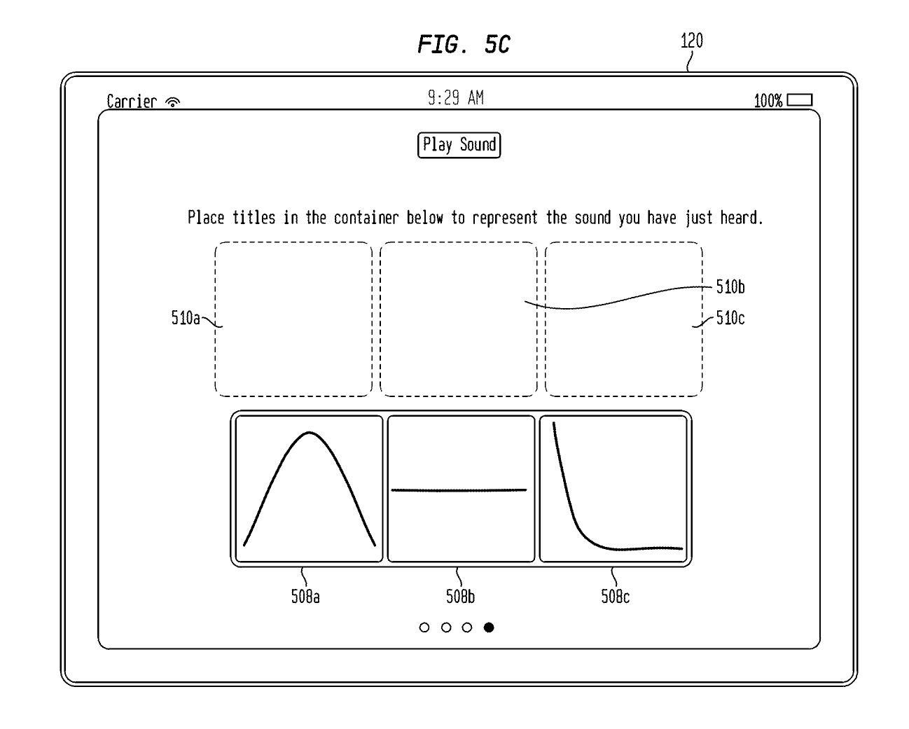

In step 402, a first context input sentence (e.g., a question) is presented to the user in a lexical audio form, via the audio output device 130 while the display/touchscreen of the user-prompting/input device 120 presents the user with a visual representation of the first context input sentence 502 as illustrated in FIG. 5A. In response, the user listens to the sentence and views the corresponding visual representation of the sentence in a passive manner.

In step 404, a second context input sentence (e.g., the answer to the question presented in step 402) is presented to the user in a lexical audio form, via the audio output device 130 while the display/touchscreen of the user-prompting/input device 120 presents the user with a visual representation of the second context input sentence 504, as illustrated in FIG. 5B and a graphical representation of the second context input sentence in the form of a pitch graph 506 that depicts the intonation contours associated with the second context input sentence. The pitch graph displays the pattern of pitch rise and fall over the sentence. In response, the user listens to the sentence and views the corresponding graphical representation of the sentence in a passive manner.

In step 406, the second context input sentence (e.g., the answer to the question presented in step 402) is presented to the user in a non-lexical audio form, via the audio output device 130 so that the user only hears the intonation features of the sentence, i.e., the pattern of pitch rise and fall over the sentence. In response, the user listens to the intonation features of the sentence.

In step 408, the user is prompted by the display/touchscreen of the user-prompting/input device 120 to actively respond to the intonation features of the sentence audibly presented in step 406 by graphically recreating the intonation contours on the display/touchscreen of the user-prompting/input device 120. In one exemplary embodiment of step 408, as illustrated in FIG. 5C, the display/touchscreen of the user-prompting/input device 120 presents the user with a random sequence of tiles 508a-c. Each of the tiles 508a-c includes a graphical representation of one of the intonation contours of the sentence presented to the user in steps 404 and 406. The display/touchscreen also presents the user with a linear sequence of containers 510a-c for placing the tiles 508a-c in the proper order to graphically recreate the pattern of pitch rise and fall over the sentence (pitch graph 506 of FIG. 5B) presented in step 404. The user graphically recreates the intonation contours by placing tiles 508a-c into the containers 510a-c in the correct sequence after listening to the non-lexical version of the sentence presented in step 406. The processor 122 determines in step 410 whether the intonation contours have been placed in the correct sequence. If the sequence is correct, the method stops in step 412. If the user places the tiles 508a-c in the containers 510a-c in the wrong sequence, then in step 414, the processor 122 causes the audio output device 130 and/or display/touchscreen of the user-prompting/input device 120 to indicate the incorrect placement. The user can then play the non-lexical form of the sentence again by pressing a button on the display/touchscreen and attempt to place the tiles in the containers in the correct sequence. The method then loops back to step 410 until the tiles have been placed in the containers in the correct sequence.

While the prominent and non-prominent portions of the audio may relate to duration and/or intonation, any other characteristics that vary among the syllables could may be used as the indicator between prominent and non-prominent.

The present embodiments are to be considered as illustrative and not restrictive. The scope of the invention is set forth in the appended claims rather than by the foregoing description and all changes which come within the meaning and the range of equivalency of the claims are therefore intended to be embraced therein.

What is claimed is:

1. A method for teaching language prosody, said method comprising the steps of:
audibly conveying a phrase or sentence;
audibly conveying a non-lexical version of at least a portion of the phrase or sentence;
prompting a language learner in a computer process to repeat said at least portion of said phrase or sentence in a non-lexical form;
determining in a computer process whether said non-lexical phrase or sentence repeated by said language learner was performed correctly; and
indicating to said language learner whether said non-lexical phrase or sentence repeated by said language learner was performed correctly.

2. The method of claim 1 further comprising the step of visually displaying a sequence corresponding to said non-lexical version of at least a portion of said phrase or sentence.

3. The method of claim 1 further comprising repeating said steps of prompting and determining for increasingly larger portions of said phrase or sentence.

4. The method of claim 3 wherein, prior to said step of prompting, further comprising the step of audibly conveying successively smaller portions of said phrase or sentence in a non-lexical form.

5. The method of claim 1 wherein the step of indicating comprises displaying a graphical representation of said language learner's repeated non-lexical phrase or sentence.

6. The method of claim 5, wherein said graphical representation comprises a symbol for prominent syllables, a symbol for less prominent syllables, and a symbol for duration of a syllable.

7. The method of claim 1 wherein said non-lexical phrase or sentence repeated by the said language learner comprises tapping on a user-prompting/input device.

8. The method of claim 1 further comprising the steps of:
prompting a language learner to repeat said portion of said phrase or sentence in a lexical form; and
determining in a computer process whether said lexical phrase or sentence repeated by said language learner was performed correctly; and
indicating to said language learner whether said lexical phrase or sentence repeated by said language learner was performed correctly.

9. The method of claim 8 further comprising the step of visually displaying a sequence corresponding to said lexical version of at least a portion of said phrase or sentence.

10. The method of claim 8 further comprising repeating said steps of prompting and determining for increasingly larger portions of said phrase or sentence in lexical form.

11. The method of claim 10 wherein, prior to said steps of prompting, further comprising the steps of:
audibly conveying a lexical version of at least a portion of the phrase or sentence; and
audibly conveying successively smaller portions of said phrase or sentence in a lexical form.

12. The method of claim 8, wherein the step of indicating comprises displaying a graphical representation of said language learner's repeated lexical phrase or sentence.

13. The method of claim 12, wherein said graphical representation comprises a symbol for prominent syllables, a symbol for less prominent syllables, and a symbol for duration of a syllable.

14. The method of claim 1, wherein said prosody comprises rhythm.

15. The method of claim 1, wherein said step of prompting of said language learner to repeat said at least portion of said phrase or sentence in said non-lexical form comprises prompting the user to reconstruct a pitch graph representing said at least portion of said phrase or sentence in said non-lexical form.

17. The method of claim 1, wherein said prosody comprises intonation.

18. A system for teaching language prosody, the system comprising:
an audio output device for audibly conveying a phrase or sentence in at least one of a lexical and a non-lexical form and portions thereof, to a language learner;
a prompting device for prompting the language learner to repeat said phrase or sentence and portions thereof and indicating to said language learner whether said phrase or sentence and portions thereof have been repeated correctly by said language learner;
at least one input device for allowing the language learner to repeat said phrase or sentence and said portions thereof in at least one of a lexical and non-lexical form; and
a controller for determining whether said phrase or sentence and portions thereof repeated by said language learner was performed correctly.

19. The system of claim 18, wherein said prosody comprises rhythm.

20. The system of claim 18, wherein said prosody comprises intonation.

21. A method for teaching language prosody, the method comprising the steps of:
in a computer process, passively exposing a language learner to audible and visual lexical and non-lexical versions of an entire phrase or sentence and to audible and visual lexical and non-lexical portions of the phrase or sentence, wherein each of the portions is smaller than the previous portion such that the entire phrase or sentence is gradually broken down into its most basic elements; and
in a computer process, prompting the language learner to actively compose lexical and non-lexical versions of the lexical and non-lexical portions of the phrase or sentence and the lexical and non-lexical versions of the phrase or sentence starting with the most basic elements and finishing with the entire phrase or sentence.

22. A computer program product comprising a computer readable medium having computer program logic recorded thereon to program a computing system reading the medium to teach language prosody, the computer program product comprising:
code for audibly conveying a phrase or sentence;
code for audibly conveying a non-lexical version of at least a portion of the phrase or sentence;
code for prompting a language learner to repeat said at least portion of said phrase or sentence in a non-lexical form;
code for determining whether said non-lexical phrase or sentence repeated by said language learner was performed correctly; and
code for indicating to said language learner whether said non-lexical phrase or sentence repeated by said language learner was performed correctly.
